(19) United States
(12) Patent Application Publication
(10) Pub. No.: US 2016/0345621 A1
(43) Pub. Date: Dec. 1, 2016

(54) PRE-VAPOR FORMULATION OF AN ELECTRONIC VAPING DEVICE AND/OR METHODS OF MANUFACTURING THE SAME

(71) Applicants: San LI, Midlothian, VA (US); Barry S. Smith, Hopewell, VA (US); Gerd Kobal, Sandy Hook, VA (US)

(72) Inventors: San LI, Midlothian, VA (US); Barry S. Smith, Hopewell, VA (US); Gerd Kobal, Sandy Hook, VA (US)

(21) Appl. No.: 15/160,236

(22) Filed: May 20, 2016

Related U.S. Application Data
(60) Provisional application No. 62/169,259, filed on Jun. 1, 2015.

(51) Int. Cl. A24B 15/16; H05B 3/14; A24B 15/32; H05B 3/00; A24F 47/00; A24B 15/34

(52) U.S. Cl. CPC A24B 15/16; A24F 47/008; A24B 15/34; A24B 15/32; H05B 3/0014; H05B 3/141

(57) ABSTRACT

A pre-vapor formulation of an electronic vaping device includes water, nicotine, glycerin (Gly), and propylene glycol. The nicotine may be included in an amount ranging from about 1.5% to about 5.0% by weight. The propylene glycol (PG) and the glycerin (Gly) may be included in respective amounts such that a weight ratio (PG-Gly) of the propylene glycol (PG) to the glycerin (Gly) ranges from about 80:20 (PG-Gly) to about 20:80 (PG-Gly).

### CROSS-REFERENCE TO RELATED APPLICATIONS

The present application claims priority under 35 U.S.C. §119(e) to U.S. Provisional Application No. 62/169,259, filed on Jun. 1, 2015, the entire contents of which are incorporated herein by reference.

### BACKGROUND

Field

The present disclosure relates to a pre-vapor formulation for an electronic vaping device including a cartridge including the pre-vapor formulation, an electronic vaping device including the cartridge, and/or a method of manufacturing the same.

Related Art

Electronic vaping devices (also referred to as e-vaping devices) may be used to vaporize a liquid material into a “vapor” in order to permit vaping by an adult vaper. The liquid material may be referred to as a pre-vapor formulation. An e-vaping device may include several elements, such as a power source and a cartridge (also referred to as a cartomizer). The cartridge may include a reservoir for holding the pre-vapor formulation and a heater for vaporizing the pre-vapor formulation to produce a vapor.

Vapor drawn from an electronic vaping device may create a sensory experience for the adult vaper. The desired sensory experience may vary among adult vapers.

### SUMMARY

At least one example embodiment relates to an e-vaping device.

In some example embodiments, depending on the composition of a pre-vapor formulation in the e-vaping device, the e-vaping device may be configured to provide different sensory experiences including different levels of harshness in the throat and/or different levels of perceived warmth in the chest.

In an example embodiment, a cartridge includes a housing including a liquid supply reservoir and a pre-vapor formulation in the liquid supply reservoir. The pre-vapor formulation includes nicotine, water, glycerin (Gly), and propylene glycol (PG). The nicotine is included in an amount ranging from about 1.5% to about 3.0% by weight. The propylene glycol (PG) and the glycerin (Gly) are included in respective amounts such that a weight ratio (PG-Gly) of the propylene glycol (PG) to the glycerin (Gly) ranges from about 80:20 (PG-Gly) to about 20:80 (PG-Gly).

The amount of nicotine may range from about 1.5% to about 2.0%. The amount of propylene glycol may be greater than an amount of the water.

The amount of water may range from about 15% to about 20% by weight. The weight ratio (PG-Gly) of the propylene glycol (PG) to the glycerin (Gly) may range from about 80:20 (PG-Gly) to about 40:60 (PG-Gly).

The amount of nicotine may be about 1.5% by weight, and the weight ratio (PG-Gly) may range from about 60:40 (PG-Gly) to about 40:60 (PG-Gly).

The pre-vapor formulation may further include menthol, and the weight ratio (PG-Gly) may range from about 80:20 (PG-Gly) to about 60:40 (PG-Gly).

The pre-vapor formulation may further include at least one flavoring additive.

The water, nicotine, propylene glycol, and glycerin may be mixed together in the pre-vapor formulation, and the weight ratio (PG-Gly) may range from about 60:40 (PG-Gly) to about 40:60 (PG-Gly).

A sum of the water, the nicotine, and a balance portion of the pre-vapor formulation may be equal to 100% by weight of the pre-vapor formulation. In other words, the balance portion of the pre-vapor formulation may correspond to the portion of the pre-vapor formulation, except for the water and the nicotine. The amount of propylene glycol in the pre-vapor formulation may range from about 80% to about 20% by weight of the balance portion of the pre-vapor formulation. The amount of glycerin in the pre-vapor formulation may range from about 20% to about 80% by weight of the balance portion of the pre-vapor formulation.

A weight of the pre-vapor formulation may range from about 200 mg to about 1000 mg.

The amount of nicotine may range from about 2.0% to about 3.0%. The weight ratio (PG-Gly) of the propylene glycol (PG) to the glycerin (Gly) may range from about 75:25 (PG-Gly) to about 20:80 (PG-Gly). The amount of propylene glycol may be greater than the amount of water.

An amount of the water may range from about 15% to about 20% by weight. The amount of nicotine may be about 2.5% by weight. The weight ratio (PG-Gly) of the propylene glycol (PG) to the glycerin (Gly) may range from about 75:25 (PG-Gly) to about 40:60 (PG-Gly).

The pre-vapor formulation may further include menthol. The weight ratio (PG-Gly) may range from about 75:25 (PG-Gly) to about 60:40 (PG-Gly).

The pre-vapor formulation may further include at least one flavoring additive.

The water, nicotine, propylene glycol, and glycerin may be mixed together in the pre-vapor formulation. The weight ratio (PG-Gly) may range from about 55:45 (PG-Gly) to about 40:60 (PG-Gly).

A sum of the water, the nicotine, and a balance portion of the pre-vapor formulation may be equal to 100% by weight of the pre-vapor formulation. In other words, the balance portion of the pre-vapor formulation may correspond to the portion of the pre-vapor formulation, except for the water and the nicotine. The amount of propylene glycol in the pre-vapor formulation may range from about 80% to about 20% by weight of the balance portion of the pre-vapor formulation. The amount of glycerin in the pre-vapor formulation may range from about 20% to about 80% by weight of the balance portion of the pre-vapor formulation.

According to an example embodiment, a cartridge may include a housing including a liquid supply reservoir and a pre-vapor formulation in the liquid supply reservoir. The pre-vapor formulation includes nicotine, water, glycerin (Gly), and propylene glycol (PG). The nicotine is included in an amount ranging from about 4.0%, to about 5.0% by weight. The propylene glycol (PG) and the glycerin (Gly) are included in respective amounts such that a weight ratio (PG-Gly) of the propylene glycol (PG) to the glycerin (Gly) ranges from about 80:20 (PG-Gly) to about 20:80 (PG-Gly).

The amount of water may range from about 15% to about 20% by weight. The weight ratio (PG-Gly) of the propylene glycol (PG) to the glycerin (Gly) may range from about 70:30 (PG-Gly) to about 40:60 (PG-Gly).

The amount of nicotine may be about 4.5% by weight, and the weight ratio (PG-Gly) may range from about 50:50 (PG-Gly) to about 40:60 (PG-Gly).

The pre-vapor formulation may further include menthol, and the weight ratio (PG-Gly) may range from about 70:30 (PG-Gly) to about 60:40 (PG-Gly).

The water, nicotine, propylene glycol, and glycerin may be mixed together in the pre-vapor formulation, and the weight ratio (PG-Gly) may range from about 50:50 (PG-Gly) to about 40:60 (PG-Gly).

A sum of the water, the nicotine, and a balance portion of the pre-vapor formulation may be equal to 100% by weight of the pre-vapor formulation. In other words, the balance portion of the pre-vapor formulation may correspond to the portion of the pre-vapor formulation, except for the water and the nicotine. The amount of propylene glycol in the pre-vapor formulation may range from about 80% to about 20% by weight of the balance portion of the pre-vapor formulation. The amount of glycerin in the pre-vapor formulation may range from about 20% to about 80% by weight of the balance portion of the pre-vapor formulation.

According to an example embodiment, a method of making a pre-vapor formulation includes preparing a mixture including nicotine, water, glycerin (Gly), and propylene glycol (PG). The nicotine is included in an amount ranging from about 1.5% to about 3.0% by weight. The water is included in an amount ranging from about 15% to about 20% by weight. The propylene glycol (PG) and the glycerin (Gly) are included respective amounts such that a weight ratio (PG-Gly) of the propylene glycol to the glycerin ranges from about 80:20 (PG-Gly) to about 20:80 (PG-Gly). The amount of propylene glycol is greater than the amount of water.

The amount of nicotine may be about 1.5% by weight. The water, nicotine, propylene glycol, and glycerin may be mixed together. The weight ratio (PG-Gly) may range from about 60:40 (PG-Gly) to about 40:60 (PG-Gly).

The method may further include adding menthol to the mixture. The weight ratio (PG-Gly) in the mixture may range from about 80:20 (PG-Gly) to about 60:40 (PG-Gly). The amount of nicotine may range from about 1.5 to about 2.0% by weight.

The amount of nicotine may range from about 2.0 to about 3.0% by weight. The water, nicotine, propylene glycol, and glycerin may be mixed together. The weight ratio (PG-Gly) may range from about 55:45 (PG-Gly) to about 40:60 (PG-Gly).

The method may further include adding menthol to the mixture, adding menthol to the mixture, The weight ratio (PG-Gly) in the mixture may range from about 75:25 (PG-Gly) to about 60:40 (PG-Gly). The amount of nicotine may range from about 2.0 to about 3.0% by weight.

According to an example embodiment, a method of making a pre-vapor formulation includes preparing a mixture including nicotine, water, glycerin (Gly), and propylene glycol (PG). The nicotine is included in an amount ranging from about 4.0% to about 5.0% by weight. The water is included in an amount ranging from about 15% to about 20% by weight. The propylene glycol (PG) and the glycerin (Gly) are included respective amounts such that a weight ratio (PG-Gly) of the propylene glycol to the glycerin ranges from about 80:20 (PG-Gly) to about 20:80 (PG-Gly). The amount of propylene glycol is greater than the amount of water.

The amount of nicotine may be about 4.5% by weight. The water, nicotine, propylene glycol, and glycerin may be mixed together. The weight ratio (PG-Gly) may range from about 50:50 (PG-Gly) to about 40:60 (PG-Gly).

The method may further include adding menthol to the mixture. The weight ratio (PG-Gly) in the mixture may range from about 70:30 (PG-Gly) to about 60:40 (PG-Gly). The amount of nicotine may be about 4.5% by weight.

According to an example embodiment, a pre-vapor formulation includes nicotine in an amount ranging from about 1.5% to about 3.0% by weight, water in an amount ranging from about 10% to about 25% by weight, glycerin (Gly) in an amount, and propylene glycol (PG) in an amount. A ratio (PG-Gly) based on weight of the amount of the propylene glycol (PG) to the amount of glycerin (Gly) ranges from about 80:20 (PG-Gly) to about 20:80 (PG-Gly). The amount of propylene glycol is greater than the amount of water.

The amount of nicotine may range from about 1.5% to about 2.0% by weight. The amount of water may range from about 15% to about 20% by weight. The weight ratio (PG-Gly) may range from about 80:20 (PG-Gly) to about 40:60 (PG-Gly).

The water, nicotine, propylene glycol (PG), and glycerin (Gly) may be mixed together. The weight ratio (PG-Gly) may range from about 60:40 (PG-Gly) to about 40:60 (PG-Gly).

The amount of nicotine may be about 1.5% by weight. The amount of water may be about 15% by weight.

A sum of the water, the nicotine, and a balance portion of the pre-vapor formulation may be equal to 100% by weight of the pre-vapor formulation. In other words, the balance portion of the pre-vapor formulation may correspond to the portion of the pre-vapor formulation, except for the water and the nicotine. The amount of propylene glycol (PG) may range from about 80% to about 20% by weight of the balance portion of the pre-vapor formulation. The amount of glycerin (Gly) may range from about 20% to about 80% by weight balance portion of the pre-vapor formulation.

The pre-vapor formulation may further include menthol. The weight ratio (PG-Gly) may range from about 80:20 (PG-Gly) to about 60:40 (PG-Gly).

An electronic device may include a cartridge and a battery section. The cartridge may include a housing, a liquid supply reservoir in the housing, and a vaporizer. The above-described pre-vapor formulation may be in the liquid supply reservoir. The vaporizer may be configured to generate a vapor from the pre-vapor formulation. The battery section may be configured to provide power to the vaporizer.

A weight of the pre-vapor formulation may range from about 200 mg to about 1000 mg.

The cartridge and the battery section may be configured to be removably coupled to each other.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a cross-sectional view of an e-vaping device according to an example embodiment.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Throughout the illustrative description, the examples, and the appended claims, a numerical value of a parameter, feature, object, or dimension, may be stated or described in terms of a numerical range format. It is to be fully understood that the stated numerical range format is provided for illustrating implementation of the forms disclosed herein, and is not to be understood or construed as inflexibly limiting the scope of the forms disclosed herein.

Moreover, for stating or describing a numerical range, the phrase “in a range of between about a first numerical value and about a second numerical value,” is considered equivalent to, and means the same as, the phrase “in a range of from about a first numerical value to about a second numerical value,” and, thus, the two equivalently meaning phrases may be used interchangeably.

A pre-vapor formulation (also referred to as vapor precursor) may be a material or combination of materials that may be transformed into a vapor. For example, the pre-vapor formulation may be a liquid, solid and/or gel formulation including, but not limited to, water, beads, solvents, active ingredients, ethanol, plant extracts, natural or artificial flavors, and/or vapor formers such as glycerin and propylene glycol.

The pre-vapor formulation may be configured to form a vapor when heated by the vaporizer in the e-vaping device. The vapor may include a particulate phase and a gas phase. The particulate phase may contain protonated nicotine. The gas phase may contain unprotonated nicotine.

When the terms “about” or “substantially” are used in this specification in connection with a numerical value, it is intended that the associated numerical value include a tolerance of ±10% around the stated numerical value unless the context indicates otherwise. Moreover, unless the context indicates otherwise, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%.

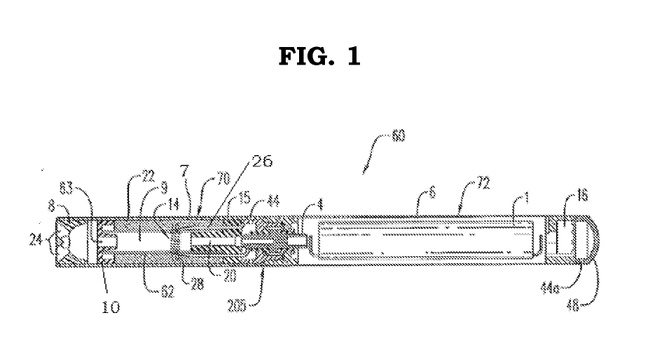

FIG. 1 is a cross-sectional view of an e-vaping device according to an example embodiment. Examples of different e-vaping devices are described in US Patent Publication No. 2013/0192623, the entire contents of which are incorporated herein by reference.

Referring to FIG. 1, in an example embodiment, an e-vaping device 60 includes a replaceable cartridge 70 and a battery section 72. The cartridge 70 and battery section 72 may be configured to be removably coupled to each other. For example, the cartridge 70 and the battery section 72 may be connected to each other and/or disconnected from each other using a threaded connection 205 or other means such as a snug-fit, a clamp and/or a clasp, but example embodiments are not limited thereto.

The battery section 72 includes a housing 6 extending in a longitudinal direction and a power supply 1 inside the housing 6. Although not illustrated, control circuitry for driving the e-vaping device may disposed inside the housing 6. The cartridge section 72 can also include a housing 7 extending in a longitudinal direction and an inner enclosure 62 positioned within the housing 7. The housing 6 may have a tubular shape. Similarly, the housing 7 may have a tubular shape. However, the respective shapes of the housing 6 and/or housing 7 are not particular limiting and may be varied depending on design considerations. In an alternative embodiment, the housings 6 and 7 of the e-vaping device may be a single outer enclosure (e.g., single tube) that surrounds both the cartridge 70 and the battery section 72 and the entire e-vaping device 60 may be disposable.

In an embodiment, the e-vaping device 60 can also include a central air passage 20 defined by a seal 15 inside the housing. The central air passage 20 may open to the inner enclosure 62 and may be in fluid communication with a conduit area 9 defined by an inner surface of the inner enclosure 62.

The e-vaping device 60 includes a liquid supply reservoir 22 between the inner enclosure 62 and the housing 7. In an example embodiment, the liquid supply reservoir 22 may be contained in an area between the housing 7 and the inner enclosure 62. The liquid supply reservoir 22 may be configured to store a pre-vapor formulation.

The liquid supply reservoir 22 may include a liquid storage material for storing the pre-vapor formulation. The liquid storage material may be a fibrous material such as cotton, but example embodiments are not limited thereto. Optionally, the liquid storage material may be omitted from the liquid supply reservoir 22.

A weight of the pre-vapor formulation in the liquid supply reservoir 22 may range from about 200 mg to about 1000 mg, but is not limited thereto and may vary as the pre-vapor formulation is consumed. The area may be sealed at an upstream end by the seal 15 and by a liquid stopper 10 at a downstream end so as to limit and/or prevent leakage of a pre-vapor formulation in the liquid supply reservoir 22. The pre-vapor formulation will be described later in more detail.

The cartridge 70 may include a vaporizer. The vaporizer may be in the inner enclosure 62. The vaporizer may be downstream of and spaced apart from the central air passage 20. The vaporizer may be configured to generate a vapor from heating the pre-vapor formulation in the liquid supply reservoir 22. The vaporizer may include a heater 14 and at least one wick 28. The heater may be in the form of a wire coil, a planar body, a ceramic body, a single wire, a cage of resistive wire or any other suitable form. The wick 28 (or a plurality of wicks 28) may be in communication with the pre-vapor formulation in the liquid supply reservoir 22 and in communication with the heater 14 such that the wick 28 disposes pre-vapor formulation in proximate relation to the heater 14. The wick 28 may be constructed of a fibrous and flexible material. The wick 28 may include at least one filament that is configured to transport pre-vapor formulation from the liquid supply reservoir 22 to the heater 14 when an adult vaper applies negative pressure to the e-vaping device 60. The wick 28 may be a bundle of filaments, such as a bundle of glass (or ceramic) filaments. The wick 28 may include a group of windings of glass filaments, preferably three of such windings, all which arrangements are capable of drawing pre-vapor formulation via capillary action via interstitial spacing between the filaments.

The battery section 72 may be configured to provide power to the vaporizer. For example, the power supply 1 in the battery section 72 may be configured to apply a voltage across the heater 14 when an adult vaper applies negative pressure to the e-vaping device 60. The power supply 1 may be electrically connected to respective ends of the heater 14 through electrical leads 26 in the cartridge section 70. A battery anode connector 4 may connect the power supply 1 to the electrical leads 26. The temperature of the heater 14 may increase due to resistive heating when the power supply 1 applies the voltage across the heater 14. If the temperature of the heater 14 increases above a boiling point of the pre-vapor formulation, the heater 14 may generate a vapor by heating the pre-vapor formulation near the heater 14.

The e-vaping device 60 also includes at least one air inlet 44 operable to deliver air to the central air passage 20 and/or other portions of the inner enclosure 62. The housing 7 may define the at least one air inlet 44. The e-vaping device 60 further includes a mouth-end insert 8. The mouth-end insert 8 may include at least two diverging outlets 24. The mouth-end insert 8 may be in fluid communication with the central air passage 20 via the conduit area 9 defined by the inner enclosure 62 and a central passage 63, which extends through the stopper 10. The central passage 63 may be defined by an inner surface of the stopper 10.

The heater 14 may extend in a direction transverse to the longitudinal direction of the inner enclosure 62. When the heater 14 receives sufficient power from the power supply 1, the heater 14 can heat the pre-vapor formulation to a temperature sufficient to vaporize the pre-vapor formulation and form a vapor.

The power supply 1 can be a battery (e.g., a Lithium-ion battery or one of its variants such as a Lithium-ion polymer battery). Alternatively, the battery may be a Nickel-metal hydride battery, a Nickel cadmium battery, a Lithium-manganese battery, a Lithium-cobalt battery or a fuel cell. Alternatively, the power supply 1 may be rechargeable and include circuitry allowing the battery to be chargeable by an external charging device. In that case, preferably the circuitry, when charged, provides power for a pre-determined number of puffs, after which the circuitry may be re-connected to an external charging device.

The housing 6 may define at least one air inlet 44a. The at least one air inlet 44a may be positioned at the upstream end of the battery section 72 adjacent to a puff sensor 16. The puff sensor 16 may sense when an adult vaper applies negative pressure to the e-vaping device 60. A puff from the adult vaper may draw air into the e-vaping device 60 through the air inlet 44a to initiate the puff sensor 16. A puff from the adult vaper may also draw air into the e-vaping device from the air inlets 44. The air inlet 44a may communicate with the mouth end insert 8 so that a draw upon the mouth end insert activates the puff sensor. The air from the air inlet 44a can then flow along the power supply 1 and to the central air passage 20 in the seal 15 and/or to other portions of the inner enclosure 62 and/or housing 7.

The e-vaping device 60 may also include control circuitry (not shown) to direct the power supply 1 to supply power to heater 14 if the puff sensor 16 senses a puff by an adult vaper. The control circuitry may also be connected to an activation light 48. The control circuitry may direct the activation light to glow (e.g., turn on) when the heater 14 receives power from the power supply 1. The activation light 48 may include a light-emitting device (LED) such as a diode, and may be at an upstream end of the e-vaping device 60. The activation light 48 may provide the appearance of a burning coal during a puff by the adult vaper. Moreover, the activation light 48 can be arranged to be visible to the adult vaper. In addition, the activation light 48 can be utilized for system diagnostics. The light 48 can also be configured such that the adult vaper can activate and/or deactivate the light 48 for privacy, such that the light 48 would not activate during vaping if desired.

The control circuitry may be programmable and may include an application specific integrated circuit (ASIC). In other example embodiments, the control circuitry may include a microprocessor programmed to carry out functions such as directing the power supply 1 to provide power to the heater 14, providing power to the activation light 14, etc.

Hereinafter, pre-vapor formulations according to some example embodiments are described. Each of the pre-vapor formulations described below may be used to fill the liquid supply reservoir 22 in the e-vaping device 60 described above with reference to FIG. 1.

In some example embodiments, the pre-vapor formulation may include nicotine, water, glycerin (Gly), and propylene glycol (PG).

The amount of nicotine in the pre-vapor formulation may range from about 1.0% by weight to about 5.0% by weight of the pre-vapor formulation. For example, the amount of nicotine may range from about 1.0% by weight to about 3.0% by weight of the pre-vapor formulation. In some example embodiments, the amount of nicotine in the pre-vapor formulation may be in a first range of about 1.5% by weight to about 2.0% by weight of the pre-vapor formulation. In other example embodiments, the amount of nicotine in the pre-vapor formulation may be in a second range of about 2.0% by weight to about 3.0% by weight of the pre-vapor formulation. In yet other example embodiments, the amount of nicotine in the pre-vapor formulation may be in a third range of about 4.0% by weight to about 5.0% by weight of the pre-vapor formulation.

The amount of water in the pre-vapor formulation may range from about 5% by weight to about 50% by weight of the pre-vapor formulation. For example, the amount of water in the pre-vapor formulation may range from about 15% by weight to about 20% by weight of the pre-vapor formulation.

In an example embodiment, the pre-vapor formulation may include nicotine, water, glycerin (Gly), propylene glycol (PG), and one or more flavoring additives. The one or more flavoring additives may be included in an amount ranging from about 0.01% to about 15% by weight (e.g., about 1% to about 12%, about 2% to about 10%, or about 5% to about 8%), based on a total weight of the pre-vapor formulation. The flavoring additive can be a natural flavoring additive or an artificial flavoring additive. The flavoring additive may be one of tobacco flavor, menthol, wintergreen, peppermint, herb flavors, fruit flavors, nut flavors, liquor flavors, and combinations thereof. However, example embodiments are not limited thereto and other flavoring additives may be suitable.

In an example embodiment, the pre-vapor formulation may include nicotine, water, glycerin (Gly), propylene glycol (PG), acid, and optionally one or more flavoring additives. The acid may be one of pyruvic acid, formic acid, oxalic acid, glycolic acid, acetic acid, isovaleric acid, valeric acid, propionic acid, octanoic acid, lactic acid, levulinic acid, sorbic acid, malic acid, tartaric acid, succinic acid, citric acid, benzoic acid, oleic acid, aconitic acid, butyric acid, cinnamic acid, decanoic acid, 3,7-dimethyl-6-octenoic acid, 1-glutamic acid, heptanoic acid, hexanoic acid, 3-hexenoic acid, trans-2-hexenoic acid, isobutyric acid, lauric acid, 2-methylbutyric acid, 2-methylvaleric acid, myristic acid, nonanoic acid, palmitic acid, 4-pentenoic acid, phenylacetic acid, 3-phenylpropionic acid, hydrochloric acid, phosphoric acid, sulfuric acid, and combinations thereof. The acid also may be incorporated in the pre-vapor formulation in the form of a salt.

In some example embodiments, adding acid to the pre-vapor formulation may reduce the perception of harshness. In pre-vapor formulations that include acids according to some example embodiments, as the nicotine concentration increases, the amount of acid may increase. For example, in an example embodiment, a pre-vapor formulation including water, about 1.5% to about 2.0% nicotine by weight, propylene glycol, glycerin, and acid may include about 0.5% of the acid by weight. In an example embodiment, a pre-vapor formulation including water, about 2.0% to about 3.0% nicotine by weight, propylene glycol, glycerin, and acid may include about 0.5% to about 1.0% of the acid by weight. In an example embodiment, a pre-vapor formulation including water, about 4.0% to 5.0% nicotine by weight, propylene glycol, glycerin, and acid may include more than 1.0% of the acid by weight.

The vapor generated from the pre-vapor formulation may include a particulate phase and a vapor phase. The levels of nicotine in the particulate phase and vapor phases of the vapor may affect adult vaper sensory experiences, such as strength or impact, harshness, and overall product acceptability. Factors affecting the nicotine level in the vapor include: nicotine levels in the pre-vapor formulation, energy applied to the pre-vapor formulation by the vaporizer of the e-vaping device to generate a vapor, mass of the vapor (e.g., mass of the particulate phase of the vapor), a ratio of propylene glycol (PG) to glycerin (Gly) ratio in the pre-vapor formulation, and a pH of the pre-vapor formulation.

The ratio of propylene glycol (PG) to glycerin (Gly) may affect the levels of nicotine in the vapor generated from a pre-vapor formulation according to some example embodiments. Since propylene glycol and glycerin have different boiling points, they evaporate at different temperatures when heated. Thus, for a pre-vapor formulation including propylene glycol, glycerin, and water, then pre-vapor formulation will evaporate differently when the propylene glycol and glycerin ratio in the pre-vapor formulation changes. Pre-vapor formulation evaporation rates are believed to be closely related to sensory experiences related to e-vaping device use, especially in sensory attributes such as strength or chest impact and throat harshness. The levels of nicotine in the vapor may be affected by pre-vapor formulation evaporation rates of the pre-vapor formulation.

Table 1 shows the nicotine levels per puff in vapors generated from pre-vapor formulations including different propylene glycol (PG) to glycerin (Gly) ratios. The pre-vapor formulations in Table 1 were tested using the same e-vaping conditions (i.e., same cartridge configuration and battery output to the vaporizer of the cartridge). The pre-vapor formulations in Table 1 each include the same amount of nicotine (1.5% by weight) and water (20% by weight), but they have different ratios of propylene glycol (PG) to glycerin (Gly).

TABLE 1
Nicotine amount per puff (Nic/puff) with respect to pre-vapor formulation

| Pre-vapor | Puff 1-20 | Puff 21-40 | Puff | |
|---|---|---|---|---|
| formulation | (mg Nic/ | (mg Nic/ | 41-60 (mg | Puff 61-80 |
| PG-Gly Ratio % | puff) | puff) | Nic/puff) | (mg Nic/puff) |
| 0-100 | 0.053 | 0.045 | 0.040 | 0.026 |
| 20-80 | 0.060 | 0.052 | 0.044 | 0.023 |
| 40-60 | 0.066 | 0.057 | 0.048 | 0.030 |
| 60-40 | 0.071 | 0.061 | 0.055 | 0.028 |
| 80-20 | 0.075 | 0.065 | 0.058 | 0.038 |
| 100-0 | 0.088 | 0.077 | 0.061 | 0.022 |

Based on the results in Table 1, the vapor mass and nicotine in the vapor generated per puff (mg nic/puff) are different with different propylene glycol to glycerin ratios in the pre-vapor formulation of the e-vaping device. Accordingly, as propylene glycol fraction in the pre-vapor formulation increases, the drawn vapor produces more strength or impact in the chest of the adult vaper, as evidenced by the increasing amount of nicotine per puff that is proportional to an increase in the concentration of propylene glycol in the pre-vapor formulation.

This effect may be due, among other reasons, to propylene glycol being less viscous than glycerin. As a result, pre-vapor formulations with a higher ratio of propylene glycol to glycerin typically have a higher wicking rate and capillary efficiency compared to pre-vapor formulations with a lower ratio of propylene glycol to glycerin.

Propylene glycol also has a lower boiling point than glycerin. As a result, generation of the vapor is easier for pre-vapor formulations that have an increased ratio of propylene glycol to glycerin. Accordingly, less battery power may be used to generate a vapor if the pre-vapor formulation includes a greater ratio of propylene glycol to glycerin. For example, under the same e-vaping conditions (i.e., same cartridge configuration and battery output to the vaporizer of the cartridge), an e-vaping device may generate vapor easier from a pre-vapor formulation including a relatively high ratio of propylene glycol to glycerin (e.g., a pre-vapor formulation including the ratio 80-20 of PG-Gly in Table 1) compared to a pre-vapor formulation including a relatively low ratio of propylene glycol to glycerin (e.g., a pre-vapor formulation including the ratio 20-80 of PG-Gly in Table 1).

As a result, the performance of the e-vaping device may be improved in terms of vapor formation efficiency and battery power usage when the ratio of propylene glycol to glycerol is increased in the pre-vapor formulation. Thus, an e-vaping device may generate vapor from a pre-vapor formulation including a relatively high ratio of propylene glycol to glycerin (e.g., a pre-vapor formulation including the ratio 80-20 of PG-Gly in Table 1) using less power from the power supply 1 applied to the heater 14 of the vaporizer compared to the amount of power the power supply 1 applies to a pre-vapor formulation including a relatively low ratio of propylene glycol to glycerin (e.g., a pre-vapor formulation including the ratio 20-80 of PG-Gly in Table 1).

Additionally, Table 1 shows for each pre-vapor formulation, the amount of nicotine per puff in the vapor generated from the corresponding pre-vapor formulation may decrease as the puff count increases. For example, referring to the vapor generated from the pre-vapor formulation including a propylene glycol to glycerin ratio (PG-Gly) of 100% in Table 1, the nicotine amount in the vapor Nic (mg/puff) is 0.088 at a puff count of 1-20 and 0.022 at a puff count of 61-80. In comparison, the nicotine levels in vapors generated from pre-vapor formulations in Table 1 that include glycerin or a mixture of propylene glycol and glycerin did not show as large of a decrease percentage wise at puff counts for 1-20 and 61-80 respectively. Accordingly, nicotine levels in vapors generated from pre-vapor formulations that include nicotine, water, propylene glycol, and glycerin may reduce less at higher puff counts compared to similar pre-vapor formulations that do not include glycerin.

Some adult vapers appreciate a visible exhaled vapor. The ratio of propylene glycol (PG) to glycerin (Gly) affects the visibility of the exhaled vapor. For a vapor generated from a pre-vapor formulation that includes nicotine, water (e.g., about 20% water), and the balance propylene glycol and/or optionally flavoring additives, the exhaled vapor may be invisible. In other words, if a weight ratio of propylene glycol to glycerin (PG-Gly) in the pre-vapor formulation is 100:0 (PG-Gly), no visible exhaled vapor may be observed. However, when the propylene glycol (PG) to glycerin (Gly) is adjusted to include glycerin, the exhaled vapor may be visible and observable. Accordingly, in an example embodiment, a pre-vapor formulation including nicotine, water, propylene glycol and glycerin provides the ability for the adult vaper to observe a visible vapor when puffing the e-vaping device. For example, a pre-vapor formulation including nicotine, water, propylene glycol, and glycerin, where the ratio of propylene glycol to glycerin (PG-Gly) is from 80:20 to 20:80, may provide the ability to generate a vapor that is visible.

When a pre-vapor formulation includes a higher ratio (PG-Gly) of propylene glycol to glycerin, the evaporation rate of the particulate phase of the vapor may increase and the levels of the nicotine in the vapor phrase of the vapor may increase as the particulate phase of the vapor evaporates, which increases the perception of strength in adult vapers. For example, under the same e-vaping conditions (i.e., same cartridge configuration and battery output to the vaporizer of the cartomizer), an adult vaper may perceive a vapor generated from a pre-vapor formulation including a relatively high ratio of propylene glycol to glycerin (e.g., a pre-vapor formulation including the ratio 80-20 of PG-Gly in Table 1) as stronger compared to a pre-vapor formulation including a relatively low ratio of propylene glycol to glycerin (e.g., a pre-vapor formulation including the ratio 20-80 of PG-Gly in Table 1).

In pre-vapor formulations according to some example embodiments, adjusting the propylene glycol ratio (PG-Gly) ratio may increase the harshness perceived by the adult vaper. When an adult vaper applies negative pressure to an e-vaping device, the amount of nicotine in the vapor may affect sensory attributes perceived by the adult vaper. Also, the location where the nicotine of the vapor is released may affect the adult vaper's sensory experience. For example, as the amount of nicotine released in the adult vaper's trachea increases, the adult vaper's perception of harshness may also increase. However, as a proportion of the nicotine released in the lung increases, the adult vaper's perception of harshness may decrease. Accordingly, for pre-vapor formulations including higher levels of nicotine (e.g., 2% nicotine by weight or more), the propylene glycol to glycerin (PG-Gly) ratio may be reduced to reduce the perception of harshness. For pre-vapor formulations including lower levels of nicotine (e.g., 1.5% nicotine and below), the propylene glycol to glycerin (PG-Gly) ratio may be increased to increase the perception of strength.

In an example embodiment, a pre-vapor formulation may include the first range of nicotine (e.g., about 1.5% to about 2.0% by weight) and water may include propylene glycol (PG), and glycerin (Gly) in respective amounts such that a weight ratio (PG-Gly) of the propylene glycol (PG) to the glycerin (Gly) ranges from about 80:20 (PG-Gly) to about 20:80 (PG-Gly). The amount of propylene glycol may be greater than the amount of water. The pre-vapor formulation may be prepared by preparing a mixture that includes nicotine, water, glycerin (Gly), and propylene glycol (PG) and optionally an acid and/or flavoring additive (e.g., menthol).

For example, the weight ratio (PG-Gly) of the propylene glycol (PG) to the glycerin (Gly) may range from about 80:20 (PG-Gly) to about 40:60 (PG-Gly), and the amount of water may range from about 15% to about 20% by weight. In another example, the amount of nicotine may be about 1.5% by weight, and the weight ratio (PG-Gly) may range from about 60:40 (PG-Gly) to about 40:60 (PG-Gly).

The pre-vapor formulation may further include at least one flavoring additive, and the weight ratio (PG-Gly) may range from about 80:20 (PG-Gly) to about 20:80 (PG-Gly). The weight ratio (PG-Gly) may be adjusted if the pre-vapor formulation includes menthol. For example, the pre-vapor formulation may further include menthol, and the weight ratio (PG-Gly) may range from about 80:20 (PG-Gly) to about 60:40 (PG-Gly).

The water, nicotine, propylene glycol, and glycerin may be mixed together in the pre-vapor formulation, and the weight ratio (PG-Gly) may range from about 60:40 (PG-Gly) to about 40:60 (PG-Gly).

In an example embodiment, a pre-vapor formulation may include the second range of nicotine (e.g., about 2.0% to about 3.0% by weight), water, propylene glycol (PG), and glycerin (Gly). The amount of propylene glycol may be greater than the amount of water. When, the nicotine in included in the pre-vapor formulation in a range from about 2.0% to about 3.0% by weight, the weight ratio (PG-Gly) of the propylene glycol (PG) to the glycerin (Gly) may be adjusted to reduce the harshness perceived an adult vaper. For example, the weight ratio (PG-Gly) in the pre-vapor formulation ranges from about 75:25 (PG-Gly) to about 20:80 (PG-Gly). The pre-vapor formulation may be prepared by preparing a mixture that includes nicotine, water, glycerin (Gly), and propylene glycol (PG) and optionally an acid and/or flavoring additive (e.g., menthol).

For example, the weight ratio (PG-Gly) of the propylene glycol (PG) to the glycerin (Gly) may range from about 75:25 (PG-Gly) to about 60:40 (PG-Gly). The amount of water may range from about 15% to about 20% by weight.

In another example, the amount of nicotine may be about 2.5% by weight, and the weight ratio (PG-Gly) may range from about 75:25 (PG-Gly) to about 40:60 (PG-Gly).

The pre-vapor formulation may further include at least one flavoring additive, and the weight ratio (PG-Gly) may range from about 75:25 (PG-Gly) to about 20:80 (PG-Gly). The weight ratio (PG-Gly) may be adjusted if the pre-vapor formulation includes menthol. For example, the pre-vapor formulation may further include menthol, and the weight ratio (PG-Gly) may range from about 75:25 (PG-Gly) to about 60:40 (PG-Gly).

The water, nicotine, propylene glycol, and glycerin may be mixed together in the pre-vapor formulation, and the weight ratio (PG-Gly) may range from about 55:45 (PG-Gly) to about 40:60 (PG-Gly).

In an example embodiment, a pre-vapor formulation may include the third range of nicotine (e.g., about 4.0% to about 5.0% by weight), water, propylene glycol (PG), and glycerin (Gly). The amount of propylene glycol may be greater than the amount of water. When the nicotine is included in the pre-vapor formulation in a range from about 4.0% to about 5.0% by weight, the weight ratio (PG-Gly) of the propylene glycol (PG) to the glycerin (Gly) may be adjusted to reduce the harshness perceived an adult vaper. For example, the weight ratio (PG-Gly) in the pre-vapor formulation ranges from about 70:30 (PG-Gly) to about 40:60 (PG-Gly). The pre-vapor formulation may be prepared by preparing a mixture that includes nicotine, water, glycerin (Gly), and propylene glycol (PG) and optionally an acid and/or flavoring additive (e.g., menthol). The water may be included in an amount ranging from about 15% to about 20% by weight of the pre-vapor formulation. The weight ratio (PG-Gly) may be adjusted if the pre-vapor formulation includes menthol. For example if the pre-vapor formulation includes menthol, the weight ratio (PG-Gly) may range from about 70:30 (PG-Gly) to about 60:40 (PG-Gly).

For example, the pre-vapor formulation may include about 4.5% by weight nicotine and the weight ratio (PG-Gly) in the pre-vapor formulation ranges from about 50:50 (PG-Gly) to about 40:60 (PG-Gly). The water, nicotine, propylene glycol, and glycerin may be mixed together in the pre-vapor formulation.

In some example embodiments, a balance portion of the pre-vapor formulation may correspond to the portion of the pre-vapor formulation, except for the water and the nicotine. The balance portion of the pre-vapor formulation may correspond to components other than water and nicotine in the pre-vapor formulation. In other words, a sum of the amount of the nicotine, an amount of the water, and an amount of the balance portion may be equal to 100% by weight of the pre-vapor formulation.

In some example embodiments, the balance portion of pre-vapor formulation may correspond to the portion of the pre-vapor formulation that includes propylene glycol, and glycerin. The amount of propylene glycol in the pre-vapor formulation may range from about 80% to about 20% by weight of the balance portion of the pre-vapor formulation. The amount of glycerin in the pre-vapor formulation may range from about 20% to about 80% by weight of the balance portion of the pre-vapor formulation. In other example embodiments, the balance portion of pre-vapor formulation may further include a flavoring additive and/or an acid.

Example embodiments having thus been described, one of ordinary skill in the art would appreciate that example embodiments may be varied in many ways. Such variations are not to be regarded as a departure from the intended spirit and scope of example embodiments, and all such modifications as would be obvious to one skilled in the art are intended to be included within the scope of the following claims.

What is claimed is:

1. A cartridge, comprising:
a housing including a liquid supply reservoir;
a pre-vapor formulation in the liquid supply reservoir, the pre-vapor formulation including nicotine, water, glycerin (Gly), and propylene glycol (PG),
the nicotine included in an amount ranging from about 1.5% to about 3.0% by weight, and
the propylene glycol (PG) and the glycerin (Gly) included in respective amounts such that a weight ratio (PG-Gly) of the propylene glycol (PG) to the glycerin (Gly) ranges from about 80:20 (PG-Gly) to about 20:80 (PG-Gly).

2. The cartridge of claim 1, wherein
the amount of nicotine ranges from about 1.5% to about 2.0%, and
the amount of propylene glycol is greater than an amount of the water.

3. The cartridge of claim 2, wherein
the amount of water ranges from about 15% to about 20% by weight, and
the weight ratio (PG-Gly) of the propylene glycol (PG) to the glycerin (Gly) ranges from about 80:20 (PG-Gly) to about 40:60 (PG-Gly).

4. The cartridge of claim 2, wherein
the amount of nicotine is about 1.5% by weight, and
the weight ratio (PG-Gly) ranges from about 60:40 (PG-Gly) to about 40:60 (PG-Gly).

5. The cartridge of claim 2, wherein
the pre-vapor formulation further includes menthol, and
the weight ratio (PG-Gly) ranges from about 80:20 (PG-Gly) to about 60:40 (PG-Gly).

6. The cartridge of claim 2, wherein the pre-vapor formulation further includes at least one flavoring additive.

7. The cartridge of claim 2, wherein
the water, nicotine, propylene glycol, and glycerin are mixed together in the pre-vapor formulation, and
the weight ratio (PG-Gly) ranges from about 60:40 (PG-Gly) to about 40:60 (PG-Gly).

8. The cartridge of claim 2, wherein
a sum of the water, the nicotine, and a balance portion of the pre-vapor formulation equals 100% by weight of the pre-vapor formulation,
the amount of propylene glycol in the pre-vapor formulation ranges from about 80% to about 20% by weight of the balance portion of the pre-vapor formulation, and
the amount of glycerin in the pre-vapor formulation ranges from about 20% to about 80% by weight of the balance portion of pre-vapor formulation.

9. The cartridge of claim 1, wherein a weight of the pre-vapor formulation ranges from about 200 mg to about 1000 mg.

10. The cartridge of claim 1, wherein
the amount of nicotine ranges from about 2.0% to about 3.0%,
the weight ratio (PG-Gly) of the propylene glycol (PG) to the glycerin (Gly) ranges from about 75:25 (PG-Gly) to about 20:80 (PG-Gly), and
the amount of propylene glycol is greater than the amount of water.

11. The cartridge of claim 10, wherein
an amount of the water ranges from about 15% to about 20% by weight,
the amount of nicotine is about 2.5% by weight, and
the weight ratio (PG-Gly) of the propylene glycol (PG) to the glycerin (Gly) ranges from about 75:25 (PG-Gly) to about 40:60 (PG-Gly).

12. The cartridge of claim 10, wherein
the pre-vapor formulation further includes menthol, and
the weight ratio (PG-Gly) ranges from about 75:25 (PG-Gly) to about 60:40 (PG-Gly).

13. The cartridge of claim 10, wherein
the pre-vapor formulation further includes at least one flavoring additive.

14. The cartridge of claim 10, wherein
the water, nicotine, propylene glycol, and glycerin are mixed together in the pre-vapor formulation, and
the weight ratio (PG-Gly) ranges from about 55:45 (PG-Gly) to about 40:60 (PG-Gly).

15. The cartridge of claim 10, wherein
a sum of the water, the nicotine, and a balance portion of the pre-vapor formulation equals 100% by weight of the pre-vapor formulation,
the amount of propylene glycol in the pre-vapor formulation ranges from about 80% to about 20% by weight of the balance portion of the pre-vapor formulation, and
the amount of glycerin in the pre-vapor formulation ranges from about 20% to about 80% by weight of the balance portion of the pre-vapor formulation.

16. A cartridge, comprising:
a housing including a liquid supply reservoir;
a pre-vapor formulation in the liquid supply reservoir, the pre-vapor formulation including nicotine, water, glycerin (Gly), and propylene glycol (PG),
the nicotine included in an amount ranging from about 4.0% to about 5.0% by weight, and
the propylene glycol (PG) and the glycerin (Gly) included in respective amounts such that a weight ratio (PG-Gly) of the propylene glycol (PG) to the glycerin (Gly) ranges from about 80:20 (PG-Gly) to about 20:80 (PG-Gly).

17. The cartridge of claim 16, wherein
the amount of water ranges from about 15% to about 20% by weight,
the amount of propylene glycol is greater than an amount of the water,
the weight ratio (PG-Gly) ranges from about 70:30 (PG-Gly) to about 40:60 (PG-Gly).

18. The cartridge of claim 16, wherein
the amount of nicotine is about 4.5% by weight, and
the weight ratio (PG-Gly) ranges from about 50:50 (PG-Gly) to about 40:60 (PG-Gly).

19. The cartridge of claim 16, wherein
the pre-vapor formulation further includes menthol, and
the weight ratio (PG-Gly) ranges from about 70:30 (PG-Gly) to about 60:40 (PG-Gly).

20. The cartridge of claim 16, wherein
the water, nicotine, propylene glycol, and glycerin are mixed together in the pre-vapor formulation, and
the weight ratio (PG-Gly) ranges from about 50:50 (PG-Gly) to about 40:60 (PG-Gly).

21. The cartridge of claim 16, wherein
a sum of the water, the nicotine, and a balance portion of the pre-vapor formulation equals 100% by weight of the pre-vapor formulation,
the amount of propylene glycol in the pre-vapor formulation ranges from about 80% to about 20% by weight of the balance portion of the pre-vapor formulation, and
the amount of glycerin in the pre-vapor formulation ranges from about 20% to about 80% by weight of the balance portion of the pre-vapor formulation.

22. A method of making a pre-vapor formulation, comprising:
preparing a mixture including nicotine, water, glycerin (Gly), and propylene glycol (PG),
the nicotine included in an amount ranging from about 1.5% to about 3.0% by weight,
the water included in an amount ranging from about 15% to about 20% by weight,
the propylene glycol (PG) and the glycerin (Gly) included respective amounts such that a weight ratio (PG-Gly) of the propylene glycol to the glycerin ranges from about 80:20 (PG-Gly) to about 20:80 (PG-Gly), and
the amount of propylene glycol being greater than the amount of water.

23. The method of claim 22, wherein
the amount of nicotine ranges from about 1.5 to about 2.0% by weight,
the water, nicotine, propylene glycol, and glycerin are mixed together, and
the weight ratio (PG-Gly) ranges from about 60:40 (PG-Gly) to about 40:60 (PG-Gly).

24. The method of claim 22, further comprising:
adding menthol to the mixture, wherein
the weight ratio (PG-Gly) in the mixture ranges from about 80:20 (PG-Gly) to about 60:40 (PG-Gly), and
the amount of nicotine ranges from about 1.5 to about 2.0% by weight.

25. The method of claim 22, wherein
the amount of nicotine ranges from about 2.0 to about 3.0% by weight,
the water, nicotine, propylene glycol, and glycerin are mixed together, and
the weight ratio (PG-Gly) ranges from about 55:45 (PG-Gly) to about 40:60 (PG-Gly).

26. The method of claim 22, further comprising:
adding menthol to the mixture, wherein
the weight ratio (PG-Gly) in the mixture ranges from about 75:25 (PG-Gly) to about 60:40 (PG-Gly), and
the amount of nicotine ranges from about 2.0 to about 3.0% by weight.

27. A method of making a pre-vapor formulation, comprising:
preparing a mixture including nicotine, water, glycerin (Gly), and propylene glycol (PG),
the nicotine included in an amount ranging from about 4.0% to about 5.0% by weight,
the water including an amount ranging from about 15% to about 20% by weight,
the propylene glycol (PG) and the glycerin (Gly) included respective amounts such that a weight ratio (PG-Gly) of the propylene glycol to the glycerin ranges from about 80:20 (PG-Gly) to about 20:80 (PG-Gly), and
the amount of propylene glycol being greater than the amount of water.

28. The method of claim 27, wherein
the amount of nicotine is about 4.5% by weight,
the water, nicotine, propylene glycol, and glycerin are mixed together, and
the weight ratio (PG-Gly) ranges from about 50:50 (PG-Gly) to about 40:60 (PG-Gly).

29. The method of claim 27, further comprising:
adding menthol to the mixture, wherein
the weight ratio (PG-Gly) in the mixture ranges from about 70:30 (PG-Gly) to about 60:40 (PG-Gly), and
the amount of nicotine is about 4.5% by weight.

30. A pre-vapor formulation comprising:
nicotine in an amount ranging from about 1.5% to about 3.0% by weight;
water in an amount ranging from about 10% to about 25% by weight;
glycerin (Gly) in an amount; and
propylene glycol (PG) in an amount,
a ratio (PG-Gly) based on weight of the amount of the propylene glycol (PG) to the amount of glycerin (Gly) ranging from about 80:20 (PG-Gly) to about 20:80 (PG-Gly), and
the amount of propylene glycol being greater than the amount of water.

31. The pre-vapor formulation of claim 30, wherein
the amount of nicotine ranges from about 1.5% to about 2.0% by weight,
the amount of water ranges from about 15% to about 20% by weight, and
the weight ratio (PG-Gly) ranges from about 80:20 (PG-Gly) to about 40:60 (PG-Gly).

32. The pre-vapor formulation of claim 31, wherein
the water, nicotine, propylene glycol (PG), and glycerin (Gly) are mixed together, and
the weight ratio (PG-Gly) ranges from about 60:40 (PG-Gly) to about 40:60 (PG-Gly).

33. The pre-vapor formulation of claim 32, wherein
the amount of nicotine is about 1.5% by weight, and
the amount of water is about 15% by weight.

34. The pre-vapor formulation of claim 32, wherein
a sum of the water, the nicotine, and a balance portion of the pre-vapor formulation equals 100% by weight of the pre-vapor formulation,
the amount of propylene glycol (PG) ranges from about 80% to about 20% by weight of the balance portion of the pre-vapor formulation, and
the amount of glycerin (Gly) ranges from about 20% to about 80% by weight of the balance portion of the pre-vapor formulation.

35. The pre-vapor formulation of claim 31, further comprising:
menthol, wherein
the weight ratio (PG-Gly) ranges from about 80:20 (PG-Gly) to about 60:40 (PG-Gly).

36. An electronic vaping device, comprising:
a cartridge including a housing, a liquid supply reservoir in the housing, and the pre-vapor formulation of claim 30 in the liquid supply reservoir, a vaporizer configured to generate a vapor from the pre-vapor formulation; and
a battery section configured to provide power to the vaporizer.

37. The electronic vaping device of claim 36, wherein a weight of the pre-vapor formulation ranges from about 200 mg to about 1000 mg.

38. The electronic vaping device of claim 36, wherein the cartridge and the battery section are configured to be removably coupled to each other.
